(19) United States
(12) Patent Application Publication
(10) Pub. No.: US 2026/0021774 A1
(43) Pub. Date: Jan. 22, 2026

(54) TRAY MOUNTING STRUCTURE FOR CYCLE HITCH CARRIER

(71) Applicant: CAR MATE MFG.CO., LTD., Tokyo (JP)

(72) Inventor: Kunito OHSE, Tokyo (JP)

(73) Assignee: CAR MATE MFG.CO., LTD., Tokyo (JP)

(21) Appl. No.: 18/994,975

(22) PCT Filed: Mar. 17, 2023
(86) PCT No.: PCT/JP2023/010710

§ 371 Date: Jan. 15, 2025

(30) Foreign Application Priority Data
Jul. 15, 2022 (JP) 2022-113904

(51) Int. Cl. B60R 9/10

(52) U.S. Cl. CPC B60R 9/10

(57) ABSTRACT

A tray mounting structure for a cycle hitch carrier allows even one person to easily and safely perform a mounting work when a tray is mounted on a base. A structure for mounting a tray to a base frame includes an engaging portion and an engaged portion on respective opposed surfaces of the base frame and the tray, and fastening portions positioned by engaging the engaging portion with the engaged portion. The engaging portion has a configuration functioning in a state where the base frame is set in a perpendicular position, and a mounting surface of the tray in the base frame is a surface positioned in an upper side when the base frame is set in a horizontal position.

### TECHNICAL FIELD

The present invention relates to a cycle hitch carrier, in particular, relates to a preferable structure for mounting a tray portion on which a bicycle is loaded.

### BACKGROUND ART

A cycle hitch carrier mounted on a hitch member mounted at a back of a vehicle has a tray (mounting frame) mounted in a direction perpendicular to a base disposed to extend rearward of the vehicle as disclosed in Patent Document 1. This is because employing such a loading configuration allows a plurality of bicycles to be loaded while reducing extension of the vehicle in a longitudinal direction.

However, a cycle hitch carrier having such a configuration often needs a work by a plurality of people when the tray is fixed to the base. When the tray is fixed to the base, the work is performed with the base being set in a perpendicular position or a horizontal position. Here, the work with the base being set in the perpendicular position generates a necessity of performing a fastening work with the tray held at a mounting position. The work with the base set in the horizontal position generates a necessity of performing a fastening work while crawling under the base and taking a balance of the tray.

### CITATION LIST

### Patent Literature

Patent Document 1: JP-A-2015-58712

### DISCLOSURE OF THE INVENTION

### Problems to be Solved by the Invention

Therefore, an objective of the present invention is to provide a tray mounting structure for a cycle hitch carrier that allows even one person to easily and safely perform a mounting work when the tray is mounted on a base.

### Solutions to the Problems

In order to achieve the above objective, a tray mounting structure for a cycle hitch carrier according to the present invention is a structure for mounting a tray to a base frame mounted to be switchable between a perpendicular position and a horizontal position with a hitch base disposed to horizontally extend from a vehicle rear portion serving as a base point. The tray mounting structure includes an engaging portion and an engaged portion on respective opposed surfaces of the base frame and the tray, and a fastening portion positioned by engaging the engaging portion with the engaged portion. The engaging portion has a configuration functioning in a state where the base frame is set in the perpendicular position, and a mounting surface of the tray in the base frame is a surface positioned in an upper side when the base frame is set in the horizontal position.

In the tray mounting structure for the cycle hitch carrier having the features as described above, the base frame is allowed to be provided with a support increasing a contact surface with the tray, and the engaging portion and the engaged portion, and the fastening portion are allowed to be provided on the opposed surfaces between the support and the tray. Having such features enables the tray to be stably held with respect to the base frame.

In the tray mounting structure for the cycle hitch carrier having the features as described above, a plurality of the engaging portions or the engaged portions may be disposed along an arrangement direction of the base frame when the base frame is set in the perpendicular position, and engagement of an engaging portion positioned at the uppermost portion may be achieved by hooking in and engagement by another engaging portion may be achieved by fitting in. Having such features enables the engaging portion positioned in a lower portion to be engaged without lifting the frame by hooking only the engaging portion positioned at the uppermost portion, thereby facilitating engagement itself.

Furthermore, the opposed surface to the base frame on the tray may be provided with a groove along a longitudinal direction of a tray main body, and the engaging portion or the engaged portion, and the fastening portion may be provided in a slider slidable in the groove. Having such features enables positioning of the tray in the longitudinal direction with respect to the base frame.

### Effects of the Invention

The mounting structure for the tray of the cycle hitch carrier having the features as described above allows even one person to easily and safely perform a mounting work when the tray is mounted on the base (base frame).

### BRIEF DESCRIPTION OF THE DRAWINGS

FIG. 1 is a perspective view illustrating a configuration of a hitch carrier to which a mounting structure according to an embodiment is applied.

FIG. 2 is a perspective view illustrating a state where a base frame is set in a perpendicular position in the hitch carrier without a tray, and a portion surrounded by a circle is a perspective view illustrating a partially enlarged view of a support.

FIG. 3 is a perspective view illustrating a state where the base frame is set in a horizontal position in the hitch carrier without the tray.

FIG. 4 is a side view illustrating a configuration of a tray main body.

FIG. 5 is a bottom view illustrating a configuration of the tray main body.

FIG. 6 is a drawing illustrating the A-A cross-sectional surface in FIG. 4.

FIG. 7 is a partially enlarged view illustrating a state where the tray is first-engaged with the base frame.

FIG. 8 is a partially enlarged view illustrating a state where the tray is fastened to the base frame.

### DESCRIPTION OF PREFERRED EMBODIMENTS

The following describes an embodiment according to a tray mounting structure for a cycle hitch carrier of the present invention in detail with reference to the drawings. The embodiment described below is a part of a preferred configuration in executing the present invention, and is regarded as a part of the present invention even if changes are made in a part of the configuration as long as the effects of the present invention is providable.

### Configuration

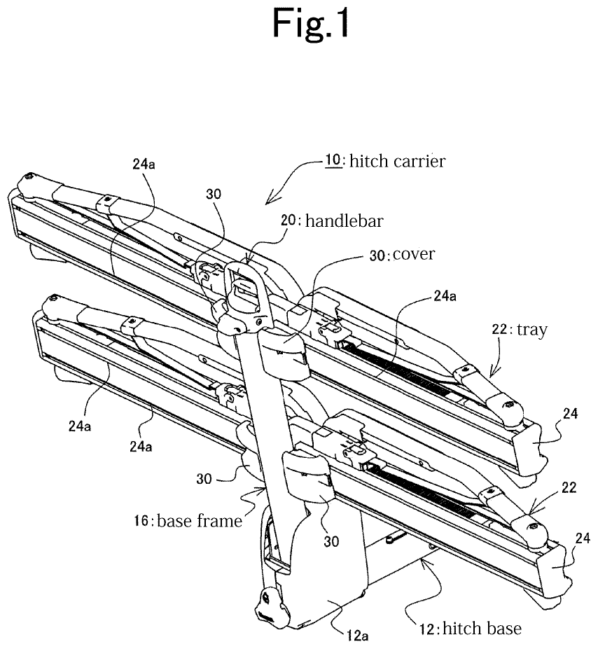

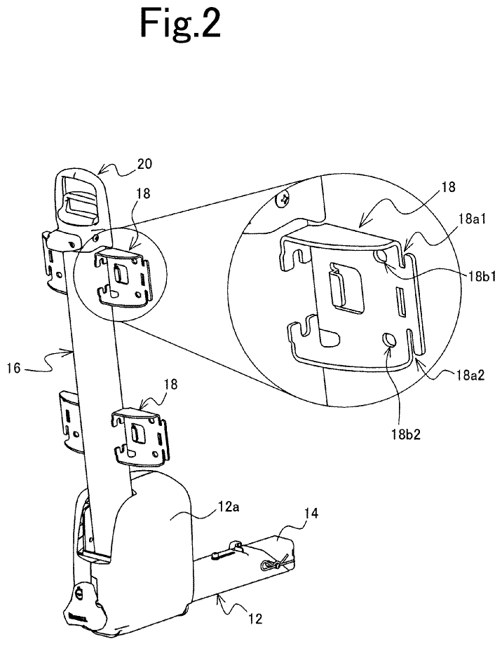

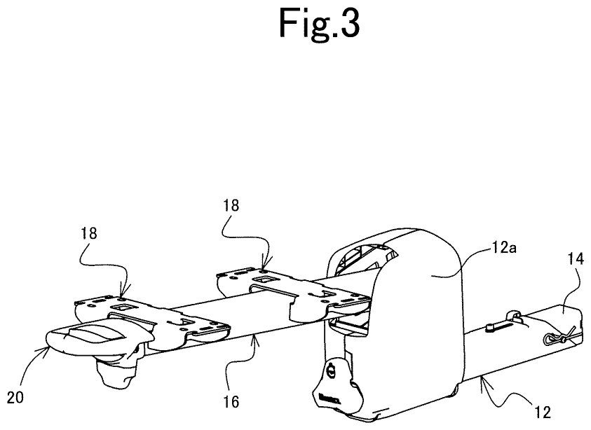

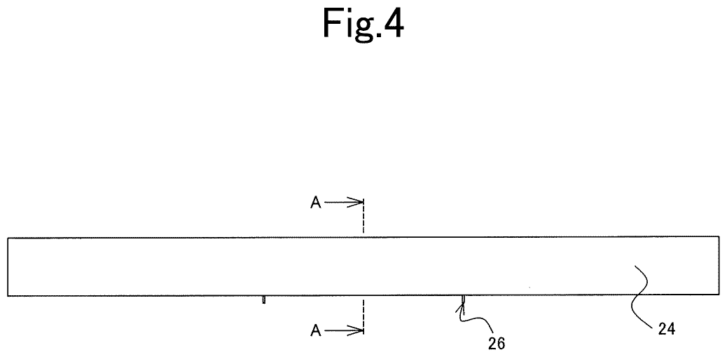

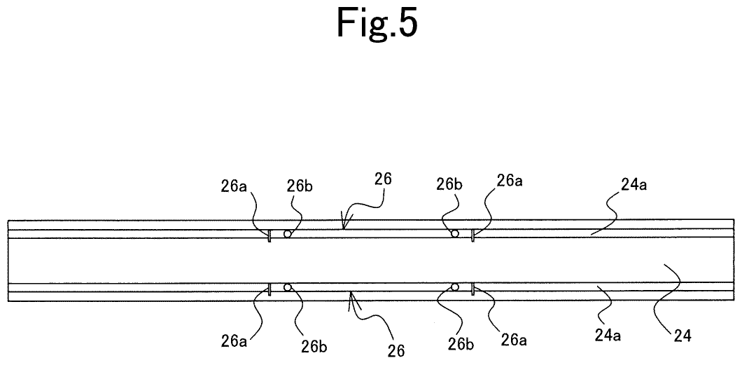

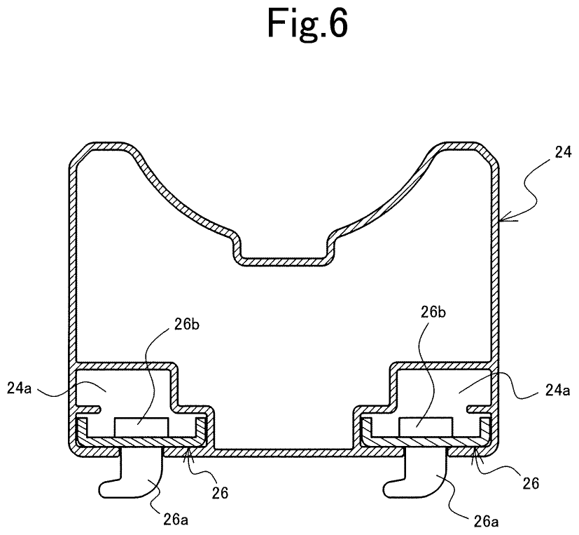

First, with reference to FIG. 1 to FIG. 6, a configuration of a hitch carrier to which a tray mounting structure for a cycle hitch carrier (hereinafter simply referred to as a hitch carrier 10) according to the present invention is applied will be described. In the drawings, FIG. 1 is a perspective view illustrating the configuration of the hitch carrier, and FIG. 2 is a perspective view illustrating a state where a base frame is set in a perpendicular position in the hitch carrier without a tray. FIG. 3 is a perspective view illustrating a state where the base frame is set in a horizontal position in the hitch carrier without the tray. FIG. 4 is a side view illustrating a configuration of a tray main body, and FIG. 5 is a bottom view illustrating a configuration of the tray main body. Furthermore, FIG. 6 is a drawing illustrating the A-A cross-sectional surface in FIG. 4.

The hitch carrier 10 according to the embodiment is configured of a hitch base 12, a base frame 16, and a tray 22 as a basic member. The hitch base 12 is a component fixed to a hitch member 14 mounted at the back of a vehicle and serving as a base of the hitch carrier 10. The hitch base 12 has a base end side serving as a fixing portion to the hitch member 14 and a distal end side serving as a connection base portion 12a of the base frame 16.

The base frame 16 is a component turnably arranged with the connection base portion 12a, which configures the hitch base 12, serving as a base end, and is able to switch between the horizontal position and the perpendicular position. The horizontal position and the perpendicular position mentioned here are not necessarily perfect horizontal or perpendicular, and are only necessary to be respective approximating positions. The base frame 16 includes a support 18 and a handlebar 20. The support 18 is a fixing member for stabilizing a supporting state of the tray 22 by the base frame 16, and is disposed to correspond to a mounting position of the tray 22 with respect to the base frame 16 (two positions in the examples illustrated in FIG. 2 and FIG. 3).

The support 18 has a plate surface extending in a direction perpendicular to an extending direction of the base frame 16 and is configured to increase an abutting surface with the tray 22. The support 18 is provided with engaged portions 18a (18a1, 18a2) formed in a groove shape and fastening portions 18b (18b1, 18b2) configured of through-holes. In the case of the configuration illustrated in FIG. 2, the engaged portions 18a are provided adjacent to an end portion in the extending direction of the plate surface configuring the support 18. In the configuration illustrated in FIG. 2, when the base frame 16 is set in the perpendicular position, there are provided the engaged portion 18a (an upper engaged portion 18a1) positioned in an upper side and the engaged portion 18a (a lower engaged portion 18a2) positioned in a lower side. The upper engaged portion 18a1 and the lower engaged portion 18a2 are provided so as to align in a straight line along the longitudinal direction of the base frame 16.

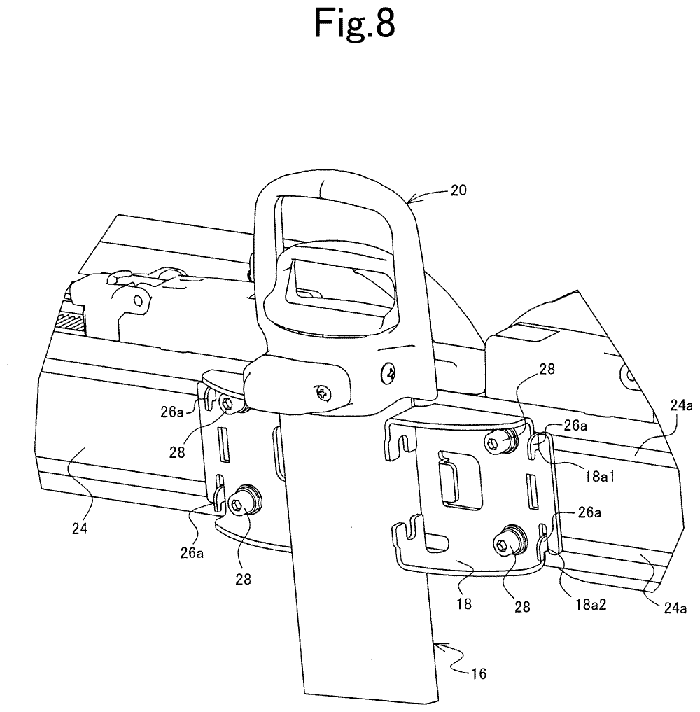

The fastening portions 18b are provided to be positioned at a side of the base frame 16 with the engaged portions 18a as references along the extending direction of the plate surface configuring the support 18. An opening of the through-hole configuring the fastening portion 18b has a size that allows a bolt 28 for fastening (see FIG. 8) to be inserted through and prohibits a head of the bolt 28 from passing through. Similarly to the engaged portions 18a, the fastening portions 18b are also provided with the fastening portion 18b (an upper fastening portion 18b1) positioned in an upper side and the fastening portion 18b (a lower fastening portion 18b2) positioned in a lower side when the base frame 16 is set in the perpendicular position, and the upper fastening portion 18b1 and the lower fastening portion 18b2 are provided so as to align in a straight line along the longitudinal direction of the base frame 16.

Fixation of the support 18 to the base frame 16 is only necessary to be by any means that allows obtainment of a stable secured state, such as welding and fastening. The handlebar 20 is a handle used when the positions (the horizontal position and the perpendicular position) of the base frame 16 are switched.

The tray 22 is a component for loading a bicycle, and is arranged with respect to the base frame 16 in a direction perpendicular to the extending direction of the base frame 16. In this application, a specific configuration of the tray 22 is not limited, but it is preferable that a tray main body 24 is configured of one material. The tray main body 24 includes a slider 26 on an opposed surface (hereinafter also referred to as a mounting surface) to the base frame 16 (the support 18). The slider 26 is a component that enables sliding along a groove 24a provided along the longitudinal direction of the tray main body 24 on the mounting surface of the tray main body 24. The slider 26 is provided with engaging portions 26a and fastening portions 26b. A pair of the grooves 24a are provided along a width direction (a direction perpendicular to the longitudinal direction) of the tray main body 24 on the mounting surface of the tray main body 24, and the sliders 26 are provided in the respective grooves 24a.

The slider 26 according to the embodiment is provided with a pair of the engaging portions 26a and a pair of the fastening portions 26b in the same member, and one engaging portion 26a is engaged with the engaged portion 18a, and thus, it is configured such that the other engaging portion 26a and fastening portion 26b are positioned. In this embodiment, the engaging portion 26a is a hook, and the fastening portion 26b is a nut having a female screw hole. The nut having the female screw hole is provided to have a hole passing through the slider 26, and the bolt 28 screwed with the female screw hole reaches a bottom surface of the groove 24a and presses the bottom surface, and thus, the slider 26 receiving a reaction is pressed onto a sliding surface of the groove 24a and the positioning is achieved.

### Actions

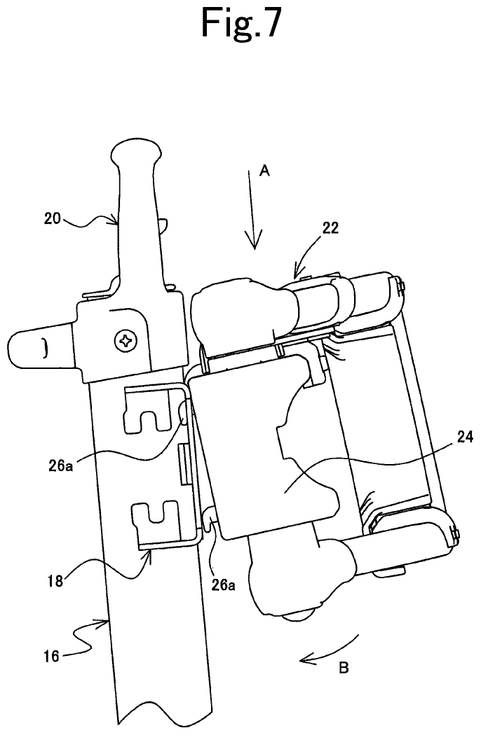

The tray 22 in the hitch carrier 10 having the configuration as described above is mounted as follows. First, the base frame 16 is disposed in the perpendicular position. In this state, as illustrated in FIG. 7, the engaging portion 26a configuring the slider 26 positioned in the upper side among the sliders 26 provided in the tray 22 is engaged with the upper engaging portion 18a1 of the support 18 (first engagement). At this time, the engagement of the tray 22 with the base frame 16 are made by moving the tray 22 in a direction indicated by the arrow A.

Next, the tray 22 is turned as indicated by the arrow B, and the engaging portion 26a configuring the slider 26 positioned in the lower side is fitted in the lower engaged portion 18b2 provided in the support 18 (second engagement).

The engaging portions 26a are positioned as described above, and thus, the fastening portions 26b provided in the slider 26 are also positioned, and the fastening portions 18b (18b1, 18b2) provided in the support and the fastening portions 26b provided in the slider 26 overlap with one another.

The fastening portions 26b of the tray 22 in a state of hooked in the support 18 by the engagement of the engaging portions 26a are screwed with the bolts 28 via the fastening portions 18b of the support 18 as illustrated in FIG. 8, thereby completing fixation of the tray 22 to the base frame 16. This is because the screwing of the bolts 28 also restricts movement of the slider 26 with respect to the tray main body 24.

After the tray 22 is fixed to the base frame 16, a cover 30 as illustrated in FIG. 1 may be mounted to the back surface of the support 18 as necessary. This is because the visual appearance as the hitch carrier 10 can be improved, and at the same time, reduction of wind noise and prevention of defacement can be achieved.

### Effects

The tray mounting structure of the hitch carrier as described above allows a fixing work to be performed with the tray 22 temporarily fastened to the base frame 16. In view of this, the mounting work is easily performed by one person. In addition, the work can be performed visually observing the fixing portion with the base frame 16 being set in the perpendicular position. Accordingly, a work in a reliable and easy posture is possible.

Since the engaging portions 26a and the fastening portions 26b are provided in the slider 26 movable along the longitudinal direction of the tray main body 24, the fastening portions 26b and the fastening portions 18b can be positioned only by engaging the engaging portions 26a with the engaged portions 18a, thereby facilitating the fastening work.

### Modifications

The above-described embodiment has described that the engaging portions 26a are provided in the slider and the engaged portions 18a are provided in the support 18 (the base frame 16) side. However, the engaging portions may be provided in the support 18 (the base frame 16) side and the engaged portion may be provided in the slider side.

The above-described embodiment has described that the slider 26 is slidable along the longitudinal direction of the tray main body 24 because of the balance when the tray 22 is mounted and the relation with the positioning of the tray 22 adjacently arranged. However, the slider 26 is not necessarily provided, and any configuration is allowed as long as the engaging portions and the engaged portions are present between the tray main body 24 and the base frame 16 (the support 18) and the positioning of the fastening portions is achieved when the engaging portions and the engaged portions are in the engaged state.

The above-described embodiment has described that the respective sliders 26 are arranged for two grooves 24a provided in the tray main body 24. However, the sliders 26 are not necessarily two, and a configuration in which a single slider straddles over two grooves 24a is also allowed.

### INDUSTRIAL APPLICABILITY

The tray 22 according to the embodiment is not necessarily used being fixed to the base frame 16 (the support 18). For example, the tray 22 according to the embodiment may be fixable to a carrier in another configuration, such as a roof carrier.

### DESCRIPTION OF REFERENCE SIGNS

10. hitch carrier, 12 . . . hitch base, 12a. connection base portion, 14. hitch member, 16 . . . base frame, 18 support, 18a . . . engaged portion, 18a1 upper engaged portion, 18a2. lower engaged portion, 18b . . . fastening portion, 18b1 . . . upper fastening portion, 18b2 . . . lower fastening portion, 20. handlebar, 22 . . . tray, 24 . . . tray main body, 24a . . . groove, 26 . . . slider, 26a . . . engaging portion, 26b fastening portion, 28. bolt, 30 . . . cover.

1. A tray mounting structure for a cycle hitch carrier that is a structure for mounting a tray to a base frame mounted to be switchable between a perpendicular position and a horizontal position with a hitch base disposed to horizontally extend from a vehicle rear portion serving as a base point, the tray mounting structure comprising:
an engaging portion and an engaged portion on respective opposed surfaces of the base frame and the tray; and
a fastening portion positioned by engaging the engaging portion with the engaged portion, wherein
the engaging portion has a configuration functioning in a state where the base frame is set in the perpendicular position, and a mounting surface of the tray in the base frame is a surface positioned in an upper side when the base frame is set in the horizontal position.

2. The tray mounting structure for the cycle hitch carrier according to claim 1, wherein
the base frame is provided with a support increasing a contact surface with the tray, and
the engaging portion and the engaged portion, and the fastening portion are provided on the opposed surfaces between the support and the tray.

3. The tray mounting structure for the cycle hitch carrier according to claim 2, wherein
a plurality of the engaging portions or the engaged portions are disposed along an arrangement direction of the base frame when the base frame is set in the perpendicular position, and
engagement of an engaging portion positioned at an uppermost portion is achieved by hooking in, and engagement by another engaging portion is achieved by fitting in.

4. The tray mounting structure for the cycle hitch carrier according to claim 1, wherein
the opposed surface to the base frame on the tray is provided with a groove along a longitudinal direction of a tray main body, and
the engaging portion or the engaged portion, and the fastening portion are provided in a slider slidable in the groove.

5. The tray mounting structure for the cycle hitch carrier according to claim 2, wherein
the opposed surface to the base frame on the tray is provided with a groove along a longitudinal direction of a tray main body, and
the engaging portion or the engaged portion, and the fastening portion are provided in a slider slidable in the groove.

6. The tray mounting structure for the cycle hitch carrier according to claim 3, wherein
the opposed surface to the base frame on the tray is provided with a groove along a longitudinal direction of a tray main body, and
the engaging portion or the engaged portion, and the fastening portion are provided in a slider slidable in the groove.
